(19) United States
(12) Patent Application Publication
(10) Pub. No.: US 2025/0104079 A1
(43) Pub. Date: Mar. 27, 2025

(54) SYSTEMS AND METHODS FOR TRAINING AND APPLYING MACHINE LEARNING SYSTEMS IN FRAUD DETECTION

(71) Applicant: The PNC Financial Services Group, Inc, Pittsburgh, PA (US)

(72) Inventors: Philip Kreckel, Pittsburgh, PA (US); Firas Kotite, San Clemente, CA (US); Andrew Lynch, Gibsonia, PA (US)

(73) Assignee: The PNC Financial Services Group, Inc, Pittsburgh, PA (US)

(21) Appl. No.: 18/976,673

(22) Filed: Dec. 11, 2024

Related U.S. Application Data
(63) Continuation of application No. 18/189,952, filed on Mar. 24, 2023.
(60) Provisional application No. 63/404,868, filed on Sep. 8, 2022.

(51) Int. Cl. G06Q 20/40

(52) U.S. Cl. CPC G06Q 20/4016

(57) ABSTRACT

Systems, methods, and computer-readable media for identifying unauthorized actions in a computing system are disclosed. Systems and methods may involve generating, by a machine learning model, a indicator that is expressed as a severity associated with unauthorized activity for a processed action. Disclosed embodiments may involve storing the indicator in a database. Disclosed embodiments may involve the system being responsive to a determination that the indicator exceeds a predetermined threshold, disclosed embodiments may involve generating an alert indicating a probability of an unauthorized action. Disclosed embodiments may involve queuing, an ordered list of generated alerts. Disclosed embodiments may involve retrieving the processed action from the database. Disclosed embodiments may involve generating a indicator from the machine learning model, the second indicator that may cause blocking of the processed action, flag the processed action, or allowing the processed action.

### TECHNICAL FIELD

The present disclosure relates to systems and methods for immediate detection of fraudulent conduct in a financial transaction using a machine learning model.

### BACKGROUND

Identifying financial transactions for potentially fraudulent conduct through ATM, Mobile, and Teller channels are some of the challenges that current fraud detection systems and methods face for detecting first-party fraud. The rise of mobile and open banking has seen fraud become more prevalent, as banks struggle with fraud due to poor infrastructure that has been built over the years.

In view of the above identified problems and deficiencies, provided herein are systems and methods that include a deposit fraud machine learning model that can be created to highlight suspicious deposits, and generate alerts corresponding to the suspicious deposits or transactions.

### SUMMARY OF THE DISCLOSURE

The disclosed embodiments include systems and methods for immediate detection of fraudulent conduct in a financial transaction using a machine learning model. The disclosed embodiments, include a deposit fraud machine learning model to notify the proposed system of suspicious deposits among financial transactions, and generate alerts corresponding to the suspicious deposits or transactions.

Embodiments of the present disclosure provide a computer-implemented method for identifying unauthorized actions in a computing system that may include at least one processor. The method may comprise generating, by a machine learning model executed by the at least one processor, an indicator that is expressed as a severity associated with unauthorized activity for a processed action of a user, the machine learning model being trained to predict a likelihood of unauthorized activity for the processed action; storing, the generated indicator in a database; responsive to a determination that the indicator exceeds a predetermined threshold, generating an alert indicating a probability of an unauthorized action; queuing an ordered list of generated alerts; retrieving the processed action from the database based on an order in which the alert is placed in the ordered list; and generating an indicator from the machine learning model to determine whether the processed action is determined to be unauthorized, wherein the generated indicator causes the at least one processor to: stop the processed action; flag the processed action for review; or allow the processed action.

Embodiments of the present disclosure provide a computing system for identifying unauthorized actions in a computing system. The at least one processor may be configured to: generate, by a machine learning model executed by the at least one processor, an indicator that is expressed as a severity associated with unauthorized activity for a processed action of a user, the machine learning model being trained to predict a likelihood of unauthorized activity for the processed action; store, the generated indicator in a database; responsive to a determination that the indicator exceeds a predetermined threshold, generate an alert indicating a probability of an unauthorized action; queuing an ordered list of generated alerts; retrieve the processed action from the database based on an order in which the alert is placed in the ordered list; and generate an indicator from the machine learning model, to determine whether the processed action is determined to be unauthorized, wherein the generated indicator causes the at least one processor to: stop the processed action; flag the processed action for review; or allow the processed action.

Consistent with other disclosed embodiments, non-transitory computer-readable storage media may store program instructions, which are executed by at least one processor device and perform any of the methods described herein. It is to be understood that both the foregoing general description and the following detailed description are exemplary and explanatory only and are not restrictive of the disclosed embodiments, as claimed.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in and constitute a part of this specification, illustrate several embodiments consistent with the disclosure and, together with the description, serve to explain the principles of the disclosure. In the drawings:

FIG. 1 depicts an exemplary illustration of a successful deposit of a user's funds into an account at an ATM channel, consistent with disclosed embodiments;

FIG. 2 depicts an exemplary illustration of a transaction for deposit of a user's funds temporarily being reviewed before being deposited into an account at an ATM channel, consistent with disclosed embodiments;

FIG. 3 depicts an exemplary illustration of an unsuccessful transaction for depositing a user's funds into an account due to an auto-hold at an ATM channel, consistent with disclosed embodiments;

FIG. 4 depicts an exemplary illustration of a successful deposit of a user's funds into an account for a mobile channel, consistent with disclosed embodiments;

FIG. 5 depicts an exemplary illustration of a transaction for deposit of a user's funds temporarily being reviewed before being deposited into an account for a mobile channel, consistent with disclosed embodiments;

FIG. 6 depicts an exemplary illustration of an unsuccessful transaction for depositing a user's funds into an account due to an auto-hold for a mobile channel, consistent with disclosed embodiments;

FIG. 7 depicts an exemplary illustration of a successful deposit of a user's funds into an account at a teller channel, consistent with disclosed embodiments;

FIG. 8 depicts an exemplary illustration of a transaction for deposit of a user's funds temporarily being reviewed before being deposited into an account at a teller channel, consistent with disclosed embodiments;

FIG. 9 depicts an exemplary illustration of an unsuccessful transaction for depositing a user's funds due to an auto-hold into an account at a teller channel, consistent with disclosed embodiments;

FIG. 10 depicts an exemplary schematic illustrating a Deposit Fraud Model to alert the current system of a suspicious check deposit through the ATM, Mobile and Teller channels, consistent with disclosed embodiments;

FIG. 11 depicts an exemplary system environment for the Deposit Fraud Model, consistent with disclosed embodiments;

FIG. 12 depicts a block diagram showing an exemplary computational device, consistent with disclosed embodiments;

FIG. 13 depicts an exemplary process flow diagram for an analytic workflow of the Deposit Fraud Model, consistent with disclosed embodiments;

FIG. 14 depicts an exemplary illustration of a trained machine learning model for generating risk indicators, consistent with disclosed embodiments;

FIG. 15 depicts an exemplary illustration of an execution of a trained machine learning model for generating risk indicators, consistent with disclosed embodiments;

FIG. 16 depicts a flowchart for a method of detecting an unauthorized transaction, consistent with disclosed embodiments;

FIG. 17A depicts an exemplary graph for model benchmarking and monitoring relating to cumulative recall, for the Deposit Fraud Model, consistent with disclosed embodiments;

FIG. 17B depicts an exemplary graph for model benchmarking and monitoring relating to relative precision for the Deposit Fraud Model, consistent with disclosed embodiments;

FIG. 18 depicts an exemplary table for a detailed feature list relating to the Deposit Fraud Model, consistent with disclosed embodiments;

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limiting.

Embodiments herein include computer-implemented methods, tangible non-transitory computer-readable media, and systems. The computer-implemented methods may be executed, for example, by at least one processor (e.g., a processing device) that receives instructions from a non-transitory computer-readable storage medium. Similarly, systems consistent with the present disclosure may include at least one processor (e.g., a processing device) and a memory, and the memory may include a non-transitory computer-readable storage medium. As used herein, a non-transitory computer-readable storage medium refers to any type of physical memory on which information or data readable by at least one processor may be stored. Examples include random access memory (RAM), read-only memory (ROM), volatile memory, non-volatile memory, hard drives, compact disc (CD) ROMs, digital optical discs (DVDs), flash drives, disks, and/or any other known physical storage medium. Singular terms, such as “memory” and “computer-readable storage medium,” may additionally refer to multiple structures, such a plurality of memories and/or computer-readable storage mediums.

As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals.

A Deposit Fraud Model assigns two-digit risk indicators, that represent multiple thresholds. The thresholds may be based on one or more factors, such as the type of deposit, the amount of money deposited, the location of where the funds were deposited into a user's account or whether a user has had previous history of fraud. As used herein, the term “indicator” may refer to a value corresponding to the risk of fraud in a user's account at a financial institution. For example, an indicator is an alternative terminology that may describe risk scoring. For example, if a risk indicator is below a first threshold, then the risk indicator may be assigned as low risk. If the risk indicator is between a first and a second threshold, then the risk indicator may be assigned as medium risk. If the risk indicator is above a third threshold, then the risk indicator may be assigned as high risk. In one example, a first threshold is “50”, a second threshold is “70”, and a third threshold is “90”, but the thresholds may have other numerical values. Similarly, in one example, the risk indicator can be a two-digit risk indicator, whereas in other examples, the risk indicator may have one-digit, three digits, or any number of digits. In one example, risk indicators may be assigned between 0-100 but in other examples, the risk indicators may have values between 0-200, 0-500, 0 and 10000, or between any other numerical range. In some embodiments, risk indicators may have alphanumerical values or may be represented by letters, words, or phrases.

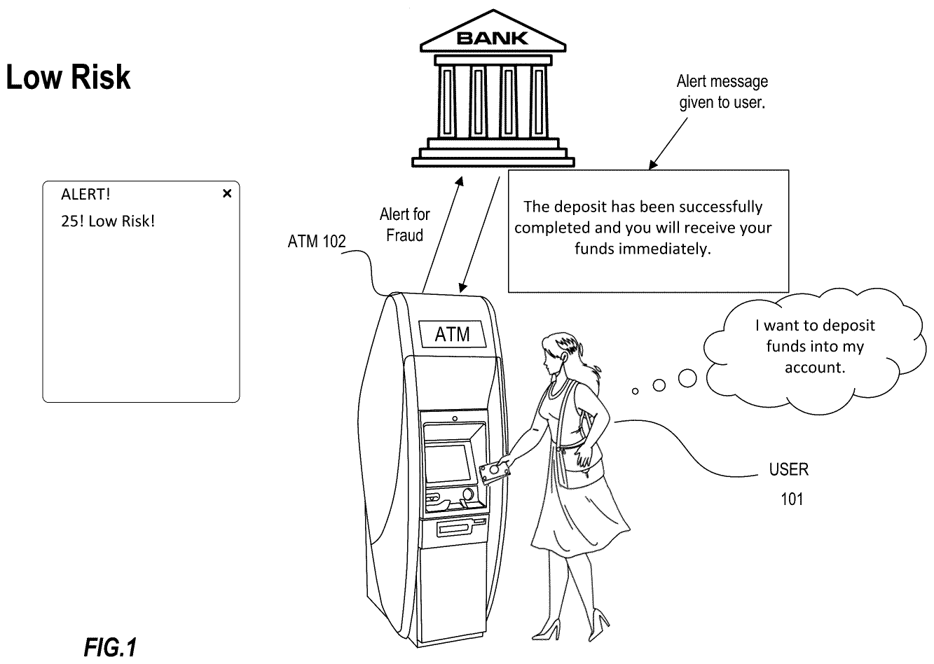

FIG. 1 depicts an exemplary illustration of a successful deposit of a user's funds into an account at an ATM channel. The Deposit Fraud Model refers to the fraud detection model that may generate an alert upon detecting suspicious deposits through ATM, Mobile, and/or Teller transaction channels. In the example depicted in FIG. 1, a user 101 approaches an ATM machine 102 and deposits funds. When user 101 deposits funds, the ATM machine 102 sends a signal to a server associated with a financial institution, in which the server is running the Deposit Fraud Model. The Deposit Fraud Model is capable of determining whether the ATM transaction is fraudulent or not. In this example, the Deposit Fraud Model may assign a risk indicator of “25” to the user's transaction. Because the risk indicator of “25” is less than a first threshold (e.g., 50), the Deposit Fraud Model may mark this transaction as a low-risk transaction and may generate an alert, indicating that it is a low-risk transaction. The Deposit Fraud Model may transmit that alert to the ATM machine 102, and based on receiving the alert, the ATM machine 102 may complete the deposit of the funds and make the funds available to the user immediately.

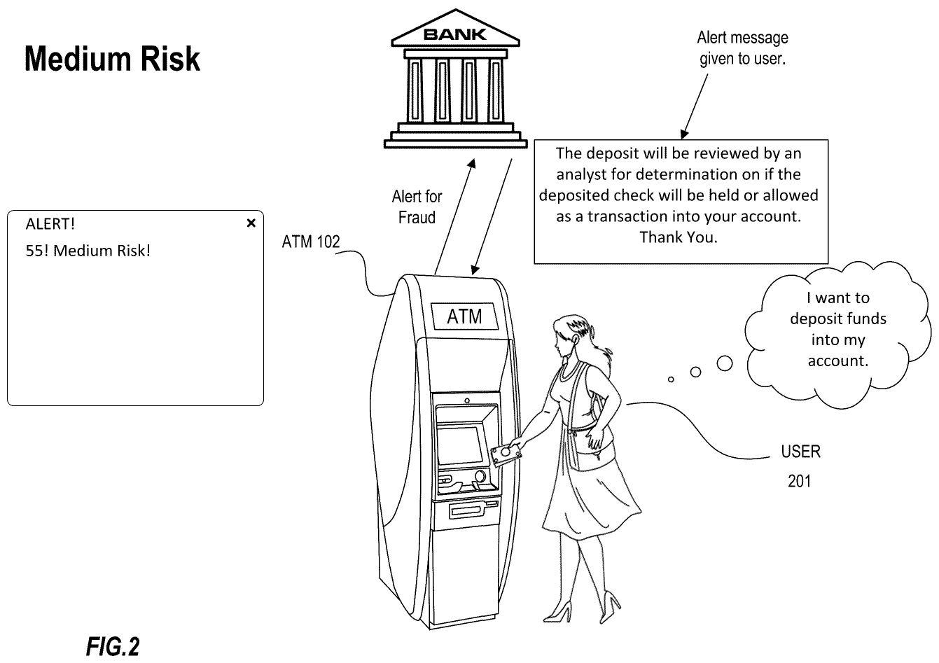

FIG. 2 depicts an exemplary illustration of another successful deposit of a user's funds into an account at an ATM channel. In this example, a user 201 approaches the ATM machine 102 and deposits funds. When user 201 deposits funds, the ATM machine 102 sends a signal to the server associated with the financial institution, in which the server is running the Deposit Fraud Model. The Deposit Fraud Model may assign the risk indicator of “55” to this transaction, for example, because the amount being deposited is much higher than what user 201 has deposited before or based on various factors. These factors may include unnecessary erasures on a check deposit and changes in user 201's handwriting combined with the financial institution verifying the signature on the check, so that the check's signature matches the signature on file for user 201, or other factors that may indicate that the deposit transaction may have a medium risk associated with it. Because the risk indicator of “55” assigned to the user's transaction is between the first threshold (e.g., 50) and the second threshold (e.g., 89), the Deposit Fraud Model may mark this transaction as a medium-risk transaction and generate an alert, indicating that it is a medium-risk transaction, the Deposit Fraud Model may transmit that indicator to the ATM machine 102, and based on the receiving alert, the ATM machine 102 may provide an indicator to user 201, that the deposit would require further review by an analyst and further that the deposited funds may not be immediately available to the user for withdrawal.

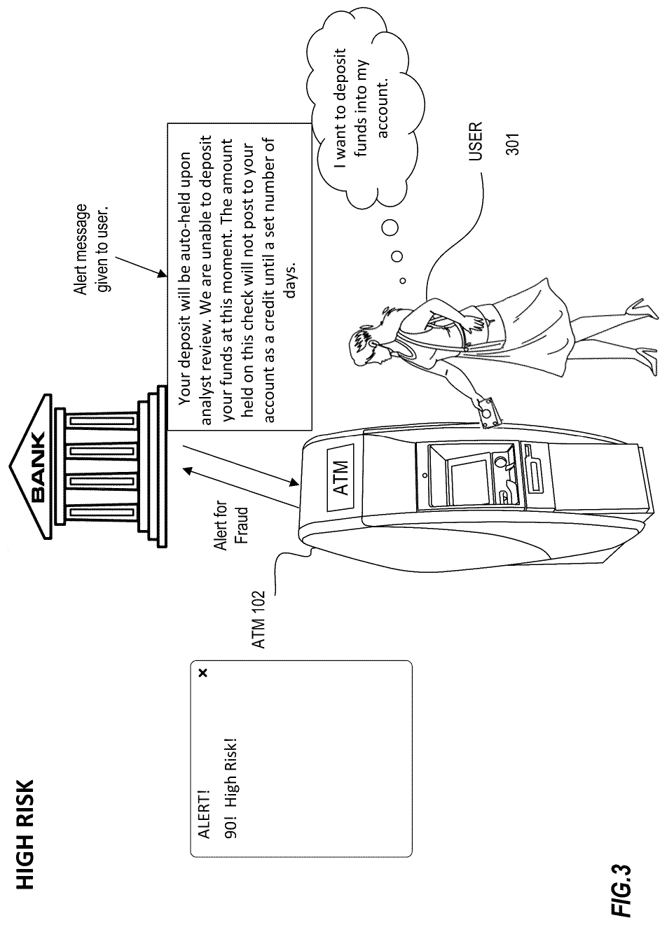

FIG. 3 depicts an exemplary illustration of an unsuccessful transaction for depositing a user's funds into an account due to an auto-hold at an ATM channel. In this example, a user 301 goes to deposit their funds into the ATM 102 at their respective financial institution. When user 301 deposits funds, the ATM machine 102 sends a signal to the server, associated with the financial institution, in which the server is running the Deposit Fraud Model. The Deposit Fraud Model may assign the risk indicator of “91” to this transaction due to factors relating to user 301's deposit, such as an unusual check amount that has not been deposited into the account before, the payee, the issuer of the check, and a fraudulent signature. Because the risk indicator of “90” is above the second threshold (e.g., 89), the Deposit Fraud Model may mark this transaction as a high-risk transaction and generate an alert, indicating that it is a high-risk transaction. The Deposit Fraud Model may transmit that indicator to the ATM machine 102, and based on receiving the alert, the ATM machine 102 may provide an indicator to user 301 that the deposit has been placed on hold and further, that user 301 may not immediately withdraw funds from their account.

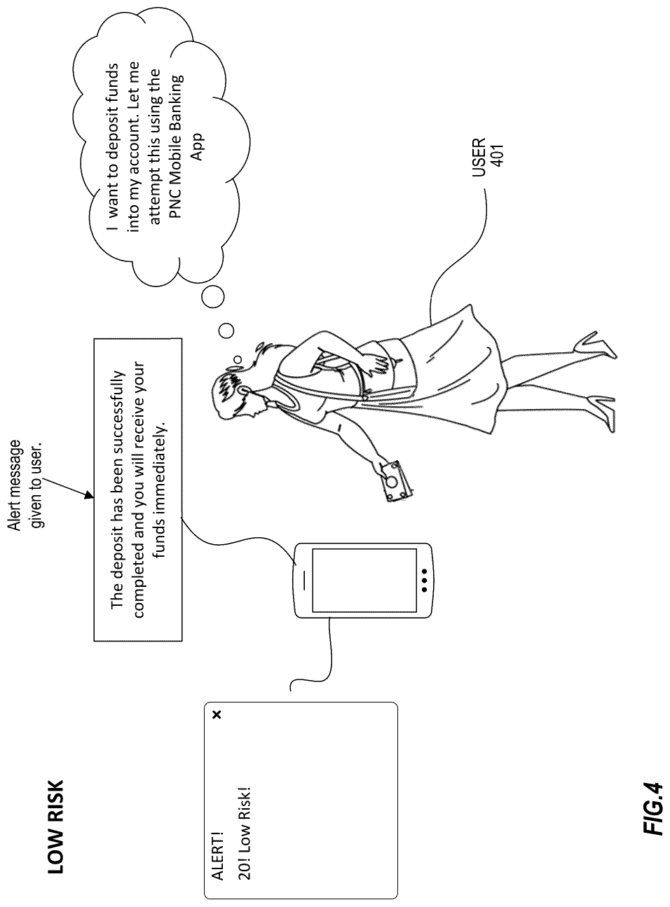

FIG. 4 depicts an exemplary illustration of a successful deposit of a user's funds into an account for a mobile channel. In this example, a user 401 may take a photo of their check, using, for example, their mobile phone. Further, the user may try to deposit the check into their account, using a mobile banking application associated with their respective financial institution. The mobile banking application may send a signal to the server associated with the financial institution, in which the server is running the Deposit Fraud Model. In this situation, the Deposit Fraud Model may assign the risk indicator of “20” to this transaction. Because the risk indicator of “20” is less than the first threshold (e.g., 50), the Deposit Fraud Model may mark this transaction as a low-risk transaction and generate an alert, indicating that it is a low-risk transaction. The Deposit Fraud Model may transmit that indicator to the mobile banking application, and based on receiving the alert, the mobile banking application may complete the deposit of the funds and indicated to the user that the deposited funds are available for immediate withdrawal.

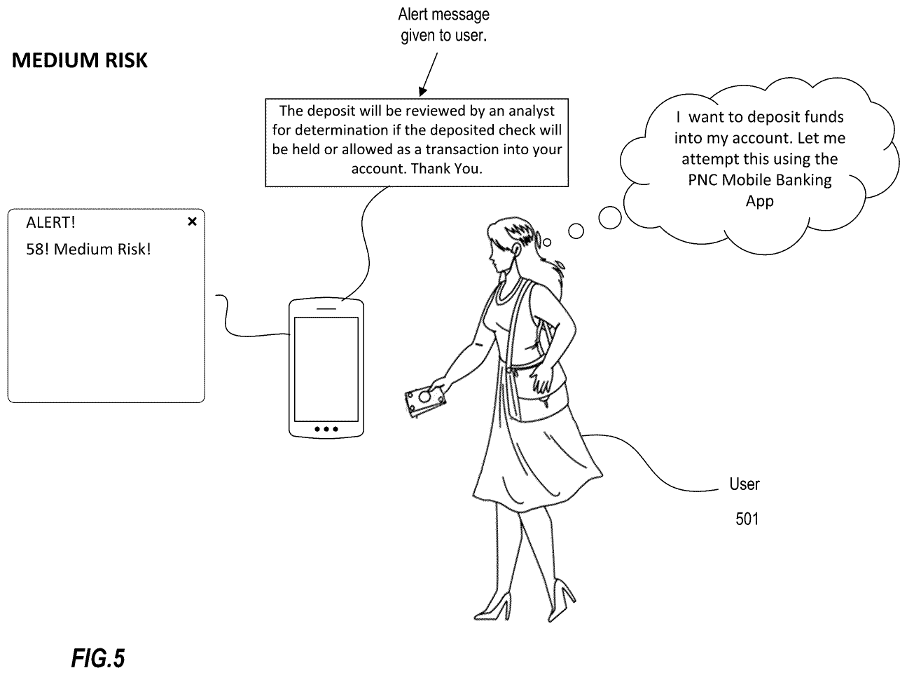

FIG. 5 depicts an exemplary illustration of a transaction for deposit of a user's funds temporarily being reviewed before being deposited into an account for a mobile channel. In this example, a user 501 takes a photo of their check to deposit funds into their account, using a mobile banking application associated with their respective financial institution. The mobile banking application sends a signal to the server associated with the financial institution, in which the server is running the Deposit Fraud Model. In this situation, the Deposit Fraud Model may assign a risk indicator of “58” to this transaction.

The Deposit Fraud Model may assign the risk indicator of “58” to this transaction due to the amount being deposited being much higher than what user 501 has deposited before or based on some of the same factors discussed above in connection with FIG. 2. Because the risk indicator of “58” assigned to the user's transaction is between the first threshold (e.g., 50) and the second threshold (e.g., 89), the Deposit Fraud Model may mark this transaction as a medium-risk transaction and generate an alert, indicating that it is a medium-risk transaction. The Deposit Fraud Model may transmit that indicator to the mobile banking application, and based on receiving the alert, the mobile banking application may indicate to user 501, that the transaction would require further review by an analyst and further that the deposited funds may not be immediately available to the user for withdrawal.

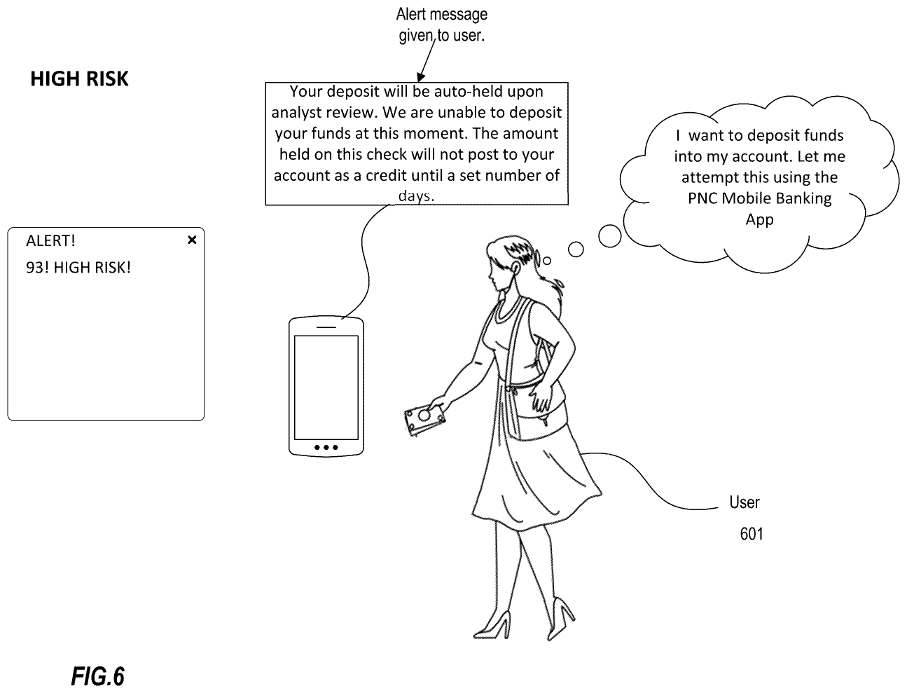

FIG. 6 depicts an exemplary illustration of an unsuccessful transaction for depositing a user's funds into an account due to an auto-hold for a mobile channel. In this example, a user 601 takes a photo of their check to deposit funds into their account, using a mobile banking application associated with their respective financial institution. The mobile banking application sends a signal to the server associated with the financial institution, in which the server is running the Deposit Fraud Model. In this situation, the Deposit Fraud Model may assign the risk indicator of “93” to this transaction.

The Deposit Fraud Model may assign the risk indicator of “93” based on factors similar to those discussed above in connection with FIG. 3. Because the risk indicator of “93” is above the second threshold (e.g., 89), the Deposit Fraud Model may mark this transaction as a high-risk transaction and generate an alert, indicating that it is a high-risk transaction. The Deposit Fraud Model may transmit that indicator to the mobile banking application, and based on receiving the alert, the mobile banking application may indicate to user 601, that the deposit has been placed on hold and further, that user 601 may not immediately withdraw funds from their account.

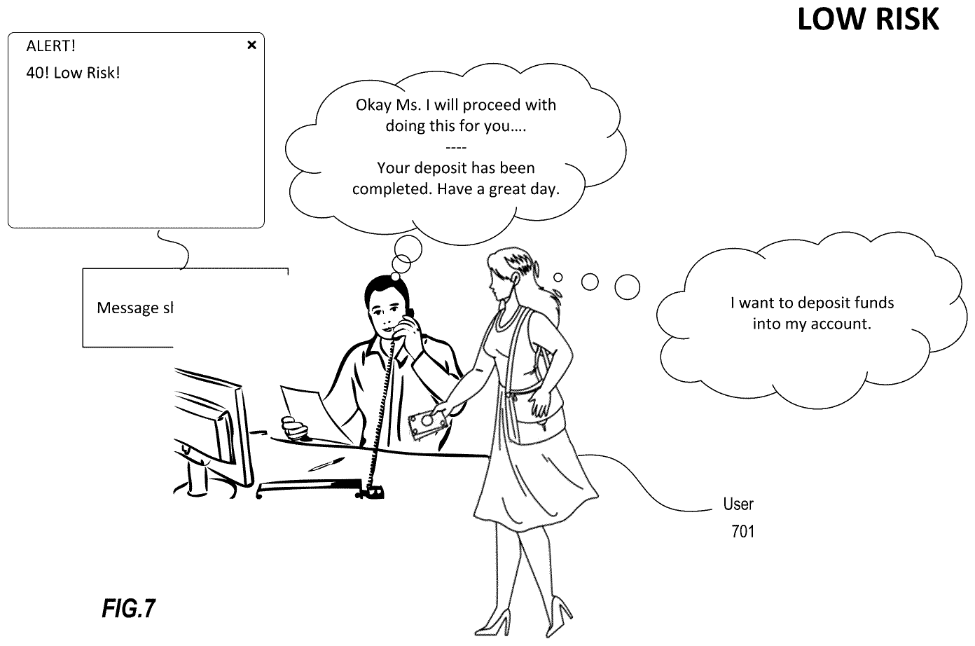

FIG. 7 depicts an exemplary illustration of a successful deposit of a user's funds into an account at a teller channel. In this situation, a user 701 approaches the teller to deposit their funds. The teller uses a computer with a teller management system that may be responsible for depositing funds, withdrawing funds, and transferring funds between accounts. When user 701 deposits funds, the teller management system sends a signal to the server associated with the financial institution, in which the server is running the Deposit Fraud Model. In this situation, the Deposit Fraud Model may assign the risk indicator of “40” to this transaction. Because the risk indicator “40” is less than the first threshold (e.g., 50), the Deposit Fraud Model may mark this transaction as a low-risk transaction and generate an alert, indicating that it may be a low-risk transaction. The Deposit Fraud Model may transmit that indicator to the teller management system, and based on receiving the alert, the teller management system may complete the deposit of the funds and make the funds available to the user immediately. The teller would notify user 701 of the successful transaction.

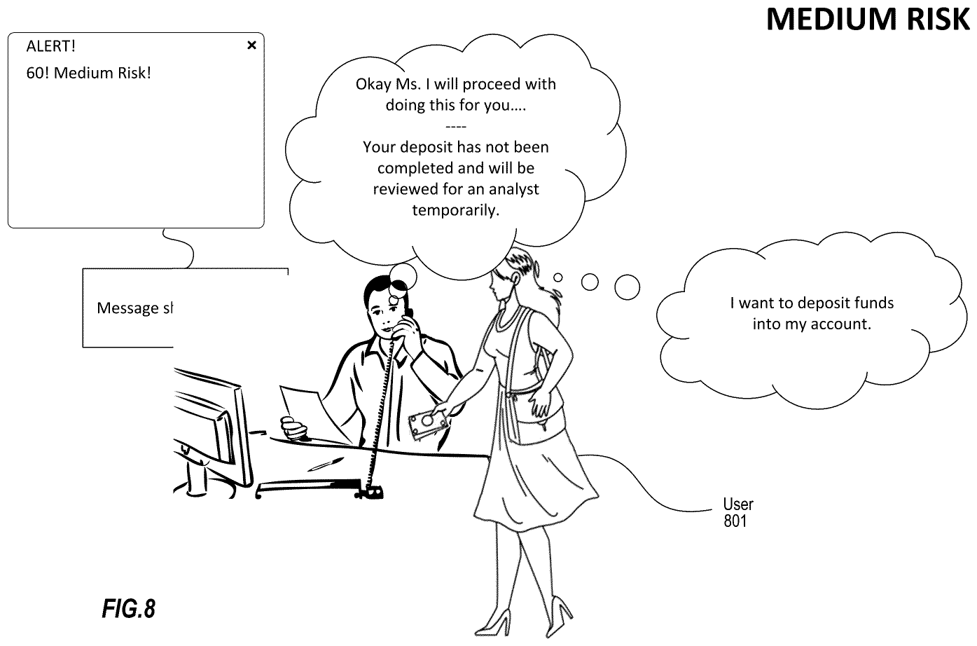

FIG. 8 depicts an exemplary illustration of a transaction for deposit of a user's funds temporarily being reviewed before being deposited into an account at a teller channel. In this situation, a user 801 approaches the teller to deposit their funds. The teller uses a computer with the teller management system that may be responsible for depositing funds, withdrawing funds, and transferring funds between accounts. When user 801 deposits funds, the teller management system sends a signal to the server associated with the financial institution, in which the server is running the Deposit Fraud Model. The Deposit Fraud Model may assign the risk indicator of “60” to this transaction. Because the risk indicator of “60” assigned to the user's transaction is between the first threshold (e.g., 50) and the second threshold (e.g., 89), the Deposit Fraud Model may mark this transaction as a medium-risk transaction and generate an alert, indicating that it may be a medium-risk transaction. The Deposit Fraud Model may transmit that indicator to the teller management system, and based on receiving the alert, the teller management system may indicate that the transaction would require further review by an analyst and further that the deposited funds may not be immediately available to the user for withdrawal.

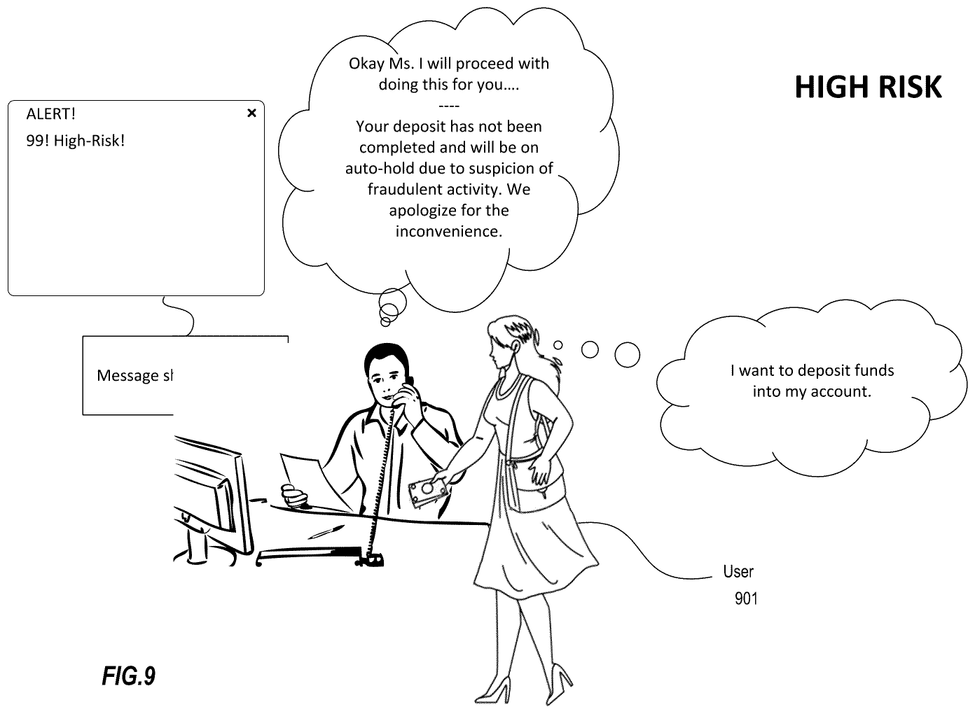

FIG. 9 depicts an exemplary illustration of an unsuccessful transaction for depositing a user's funds, due to an auto-hold, into an account at a teller channel. In this situation, user 901 approaches the teller to deposit their funds. The teller uses a computer with the teller management system that may be responsible for depositing funds, withdrawing funds, and transferring funds between accounts. The teller management system sends a signal to the, server associated with the financial institution, in which the server is running the Deposit Fraud Model. The Deposit Fraud Model may assign the risk indicator of “99” based on factors similar to those discussed above in connection with FIG. 3. Because the risk indicator of “99” is above the second threshold (e.g., 89), the Deposit Fraud Model may mark this transaction as a high-risk transaction and generate an alert, indicating that it is a high-risk transaction. The Deposit Fraud Model may transmit that indicator to the teller management system, and based on receiving the alert, the teller management system may indicate that the deposit has been placed on hold and further that user 901 may not immediately withdraw funds from their account.

In some embodiments, the risk indicator may be derived from a model probability. The model probability as used herein may refer to a probability that an input belongs to a class based on a trained model, such as a class indicating a higher likelihood of fraudulent activity. The inputs may refer to transactional data that includes customer characteristics and historical data that are used for the trained model. Transactional data as used herein may refer to transaction information that may be enriched. Enriched as used herein may refer to appending transactional information about the account, e.g., the most recent transaction or details regarding the most recent transaction such as the date, time, location, etc. Appending, as used herein, may refer to the process of supplementing information within an internal database with additional data from external sources. Customer characteristics as used herein may refer to deposit account information that may be enriched with information from that individual's other accounts at their financial institution. Customer characteristics may be enriched through the Deposit Fraud Model appending deposit account information with additional information from the individual's other accounts. Deposit account information may include the account type, the name of the account holder, the current account balance, the opening date of the account, and the account number. Historical data may refer to past information relating to the individual's account, that may be used to enrich the transaction. Historical data may be enriched through the Deposit Fraud Model by appending historical information relating to the individual's account. Historical information may include a chronological listing of all transactions that took place in the individual's account, the age of the account, account balance history, overdraft history, and account statements.

The model probability for the Deposit Fraud Model may reveal that a transaction belongs to “class 1” due to the value of the two-digit risk indicator. Class 1 as used herein may refer to the specific category or model that the trained model may predict. For example, class 1 in the Deposit Fraud Model signifies that there may be a higher likelihood that the deposit returns as fraudulent. The risk indicator of “92” would likely indicate that the transaction belongs to class 1, while the risk indicator of “20” would likely indicate that the transaction has a lesser chance of belonging to class 1.

In some embodiments, the risk indicator may be further generated based in part on log-scaling a user's profile against the user's profile. A user's profile may refer to the user's bank account at the financial institution. Log-norm scaling may refer to applying a logarithmic transformation to values, which transforms the values onto a scale that approximates the normality. For example, the Deposit Fraud Model may consider the dollar amount of a deposit and calculate a log-normal probability density score. The log-normal probability density score as used herein may refer to two parameters μ and σ, where x>0: μ is an allocation parameter and σ is a scale parameter of distribution. The log-normal probability density score may be calculated by determining where the transaction amount falls within a score distribution, in which the score distribution refers to a pattern of scores that occur within a data set. In this case, the score distribution would consist of different deposit transaction amounts.

A probability value as used herein may refer to the probability of observing a test statistic (i.e., a summary of the data) that is as extreme or more extreme than a currently observed test statistic under a statistical model that assumes, that a hypothesis being tested is true. The probability value represents how often someone would expect to see a test statistic as extreme or more extreme than the one calculated by a statistical test if a null hypothesis of that test was true. A p value gets smaller as the test statistic calculated from the data is further away from a range of test statistics predicted by the null hypothesis. For example, for probability values between 0 and 1, a probability value close to 1 would signify that the transaction amount is an unusual amount and not likely to belong to the user's activity. This signifies that there may be a likelihood of recent fraudulent activity. Furthermore, a probability value closer to 0, would mean that the transaction amount is a typical amount for the user's activity based on historical transactions associated with the account, and would not signify that the account has had any recent fraudulent activity.

In some embodiments, a risk indicator may be assigned to a transaction based on at least one of a Virtual Private Network (VPN) indicator or an indicator relating to proprietary knowledge (IP). VPN as used herein may refer to a network that conceals the location and IP address of a user, making it difficult to detect the location of the person trying to deposit the funds. Because it is difficult to detect the location, the Deposit Fraud Model may assign a higher risk to the transaction. The risk level may be based on whether the transaction is being performed through VPN. Proprietary knowledge as used herein, may refer to privileged or confidential commercial or financial information. For example, the financial institution may have information about past transactions such as unusual sums of money being deposited into the account (e.g., very large sums interspersed with very small sums). This information would be kept confidential, i.e., proprietary, to the financial institution, to better analyze fraudulent activity associated with the user's account. The Deposit Fraud Model may compare any current transaction to these past transactions to determine whether the current transaction is unusual and may then flag the transaction as medium risk or high risk based on the comparison.

Some embodiments involve a computer-implemented method for identifying unauthorized actions in a computing system including at least one processor.

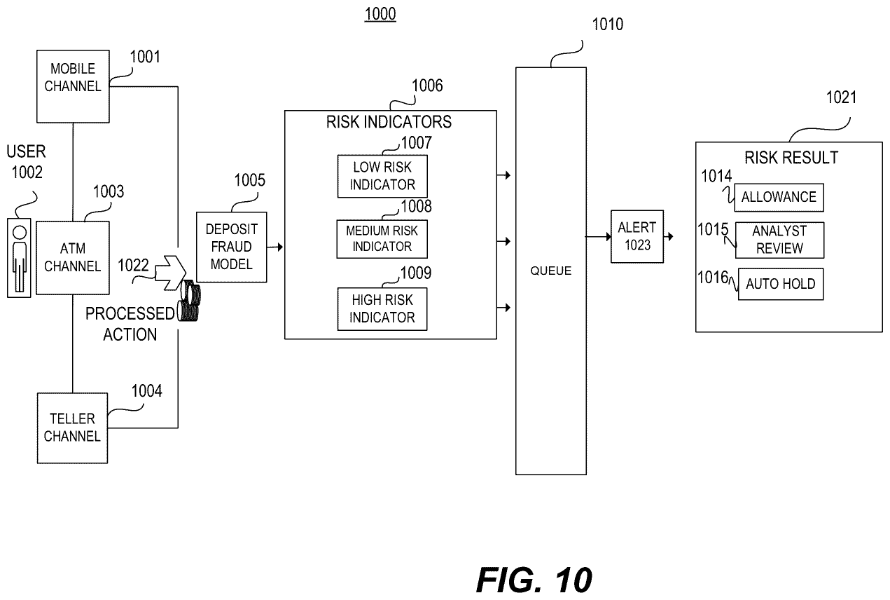

FIG. 10 depicts an exemplary system 1000 for identifying unauthorized or fraudulent transactions or for detecting suspicious deposits or withdrawals made through the ATM, Mobile, and/or Teller transaction channels. An unauthorized action as used herein, may refer to any action relating to a deposit of funds into or a withdrawal of funds from a user's account that has not been authorized or approved by the financial institution. The deposit of funds into or withdrawal of funds from a user's account may be authorized by the financial institution by evaluating a transaction associated with the deposit or withdrawal of funds using the Deposit Fraud Model 1005, shown as block 1005 in FIG. 10.

System 1000 may include at least one or more transaction channels, including, for example, a mobile channel 1001, an ATM channel 1003 and a teller channel 1004. In system 1000, Deposit Fraud Model 1005 may act on a processed action 1022 to generate risk indicators 1006. Further, Deposit Fraud Model 1005 may utilize queue 1010, an alert 1023 and risk result 1021.

An ATM channel as used herein may refer to, a self-service machine that may allow a user to deposit funds into or withdraw funds from the user's account. For example, as depicted in FIG. 10, user 1002 may deposit their funds via ATM channel 1003.

A mobile channel as used herein may refer to banking services that may be accessed through a mobile device such as a smartphone. Additionally, within the mobile device, the banking services may be accessed through a mobile banking application. For example, user 1002 may have access to the same services as an ATM channel 1003, via mobile channel 1001, when using the mobile banking application on a mobile device. Mobile channel 1001 may provide access for downloading a mobile banking app to deposit funds into or withdraw funds from an account associated with user 1002. A teller channel as used herein may refer to the standard client-to-customer interaction between a customer and a bank teller employed by a financial institution. For example, user 1002 may be able to communicate via teller channel 1004 at their respective financial institution to deposit or withdraw funds during regular business hours.

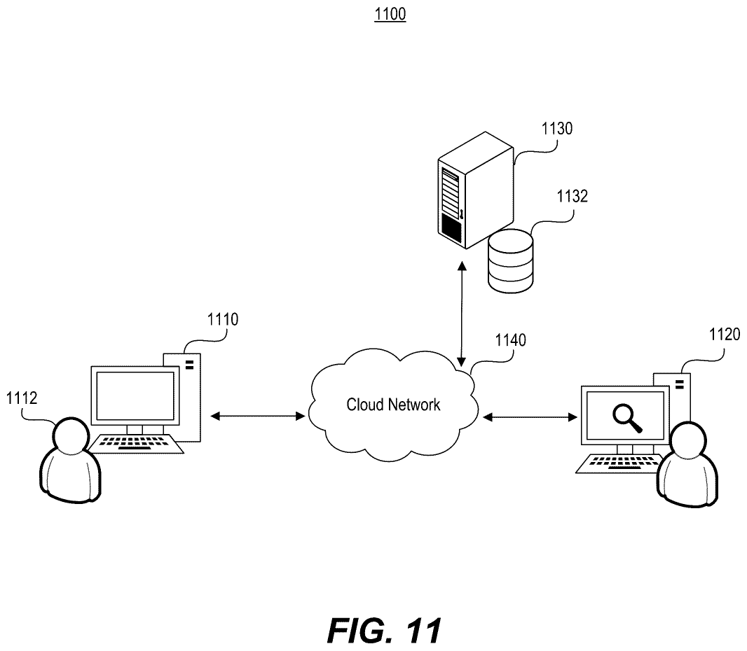

A processed action as used herein may refer to an action that may be executed by a computer program or system for a financial transaction. This may include a deposit made to a transaction account, such as a checking account. Examples of a processed action may include user 1002 depositing their funds in person at a bank via teller channel 1004, through an ATM channel 1003, or via a mobile channel 1001. For example, as shown in FIG. 10, user 1002 may deposit funds via one or more of three different transaction channels; 1) Mobile channel 1001, 2) ATM channel 1003, or 3) Teller channel 1004. When the transaction is executed via any one of these transaction channels, it initially proceeds by transaction information being transmitted electronically through the financial institution's computer system via a cloud network 1110 (see FIG. 11). Any one of the transaction channels may connect to network 1110 through an internet connection or data network, that may encrypt the transaction information. Once the data from the transaction reaches the financial institution's computer system, it may then be processed using Deposit Fraud Model 1005. In this way, each transaction performed by the user may be processed by the financial institution's computer system. The processing of a transaction by a processor or computer system associated with the financial institution is the processed action.

System 1000 includes risk indicators 1006 that may include a low risk indicator 1007, a medium risk indicator 1008, and a high-risk indicator 1009. In some embodiments, the indicator is a two-digit number that indicates the probability of unauthorized activity. For example, deposits may be assigned a two-digit risk indicator between 0-99, with 0 representing the lowest risk and 99 representing the highest risk. The risk indicator may be expressed as a severity associated with unauthorized activity for a processed action. Severity as used herein may refer to a degree of risk associated with the user's account due to unauthorized activity. Severity is determined based on a likelihood of fraudulent activity. High severity constitutes a higher likelihood of fraudulent activity for a user's account, while low severity constitutes a lower likelihood of fraudulent activity for a user's account. The risk indicators represent severity by assigning higher risk indicators to deposits that have a higher likelihood of resulting in fraudulent activity. For example, when a user who normally makes withdrawals in the range of $50-$200 makes a large withdrawal of $10,000, the Deposit Fraud Model 1005 may flag the large withdrawal as having a high severity of unauthorized activity. In contrast, if the same user were to make a withdrawal of $300 the Deposit Fraud Model 1005 may flag the withdrawal as having a low severity of unauthorized activity because the withdrawal amount, though larger, is not unusually large compared to the normal withdrawals in the range of $200.

System 1000 includes queue 1010. In some embodiments, system 1000 may involve queuing of an ordered list of generated alerts that includes ordering the generated alerts according to their respective risk indicators. Queuing as used herein may refer to the arrangement of risk scores into a queue. In some embodiments, the system 1000 may form a queue 1010, including an ordered list of generated alerts. An ordered list as used herein may refer to the ordering of items in a specific order. For example, upon an alert being generated by the Deposit Fraud Model 1005 for a particular transaction, one of the risk indicators 1006, may be categories of low risk indicator 1007, medium risk indicator 1008, and high-risk indicator 1009 may be assigned to the particular transaction based on their respective predetermined thresholds. The particular transaction will then be placed into queue 1010, at a position based on the assigned risk, i.e., low, medium, or high. Further, in one example, alerts associated within a single risk category, e.g., medium risk transactions having risk indicators 50, 57, 59 may be arranged in an ascending order within their risk category in queue 1010, so that the analyst may review, beginning with the transaction having the highest risk indicator. Medium risk transactions are queued due to their needing to be reviewed by an analyst. As another example, a first transaction may have the risk indicator “25”, a second transaction with “55”, and a third transaction with a “95”. All three of these transactions will be placed in queue 1010 in ascending order within their respective risk categories, i.e., low, medium, or high, according to their risk indicators.

System 1000 includes alert 1023. An alert as used herein may refer to a notification generated by the Deposit Fraud Model 1005 and transmitted to the at least one or more transaction channels mentioned above, to indicate whether a deposit has been determined to be fraudulent. In some embodiments, system 1000 may involve the queuing of generated alerts includes ordering the generated alerts according to their respective probabilities of unauthorized activity. For example, alert 1023 may be generated based on a comparison of the risk indicators to one or more thresholds. For example, transactions with risk indicators below the first threshold may be deemed low risk, transactions with risk indicators between the first and second thresholds may be deemed medium risk and transactions with risk indicators higher than the second threshold may be high risk. Alerts 1023 are queued according to their risk indicators relative to the respective thresholds, of the low-risk indicator 1007, medium risk indicator 1008, and high risk indicator 1009. In one example, for risk indicators above “99”, an alert 1023 indicates that the deposit activity is suspicious or fraudulent. In some embodiments, the alert may be generated at a set interval to periodically monitor and detect for unauthorized activity. The set interval may refer to when the Deposit Fraud Model 1005 is applied to the transactions. For example, the Deposit Fraud Model 1005 may generate risk indicators every hour, every two hours, or at any other desired interval.

System 1000 includes risk result 1021. Risk result as used herein may refer to individual outcomes based on the risk indicators. As depicted in FIG. 10, risk results 1021 may include outcomes relating to allowance, analyst review, and auto-holding. In some embodiments, allowing the processed action comprises automatically allowing one or more processed actions associated with indicators that are below a predetermined threshold. For example, the processed action 1022 from queue 1010, when assigned a low risk indicator 1007, would result in an allowance 1014. In one example, allowance 1014 may allow user 1002 to have access to their deposited funds immediately. In some embodiments, flagging the processed action, may include flagging for review by an analyst, if the indicator is between a certain threshold. As another example, the processed action 1022 from queue 1010, when assigned medium risk indicator 1008, would result in an analyst review 1015. Once the processed action 1022 has been flagged for review by the Deposit Fraud Model 1005, analyst review 1015 may be implemented manually by an analyst, who may decide to hold or allow the transaction.

In some embodiments, stopping the processed action comprises automatically holding the processed action if the risk indicator exceeds a predetermined threshold. Auto-hold or auto-holding as used herein, may refer to not granting user 1002 the funds associated with the transaction for a set of number of days. For example, if user 1002 deposits a check, and the deposit has been assigned the high risk indicator 1009, the outcome or risk result 1021 would correspond to auto-hold 1016. In this case, the amount reflected on the check does not post to the user 1002's account as a credit until a set number of days have passed. This may allow time for an analyst to review and decide to hold or approve the funds. The set number of days may include 1 day, 2 days, 3 days, 1 week, or any other predetermined period of time.

FIG. 11 illustrates an example system environment 1100 for predicting an outcome of one or more deposit fraud claims, consistent with the disclosed embodiments. System environment 1100 may include one or more financial institution endpoint devices 1110, one or more user endpoint devices 1120, and one or more computing device 1130, as shown in FIG. 1. System environment 1100 may represent a system or network environment in which activities of a user 1112 on financial institution endpoint device 1110 are recorded and stored on computing device 1130. A user 1112 may then view these recorded activities on user endpoint device 1120. The recording, transmission, and storage of the recorded user activity may be performed in a secure manner, such that only financial endpoint device 1110 and user endpoint device 1120 may have access to the recorded activity.

The various components of system 1100 may communicate over a network 1140. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 1100 is shown as a network-based environment, it is understood that in some embodiments, one or more aspects of the disclosed systems and methods may also be used in a localized system, with one or more of the components communicating directly with each other.

User endpoint device 1120 may be configured such that user 1112 may access a protected navigation location through a browser or other software executing on user endpoint device 1120. As used herein, a protected navigation location may be any network location deemed sensitive. As used herein, sensitive may refer to confidential information that requires protection from unauthorized access.

User endpoint device 1120 may include any form of computer-based device or entity through which user 1112 may access a protected navigation location. For example, user endpoint device 1120 may be a personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an IoT device (e.g., smart home devices, industrial devices, etc.), or any other device that may be capable of accessing web pages or other network locations. In some embodiments, user endpoint device 1120 may be a virtual machine (e.g., based on AWS™, Azure™, IBM Cloud™, etc.), container instance (e.g., Docker™ container, Java™ container, Windows Server™ container, etc.), or other virtualized instance. Using the disclosed methods, activity of user 1112 through user endpoint device 1120 may be monitored and recorded by a browser extension executing on user endpoint device 1120.

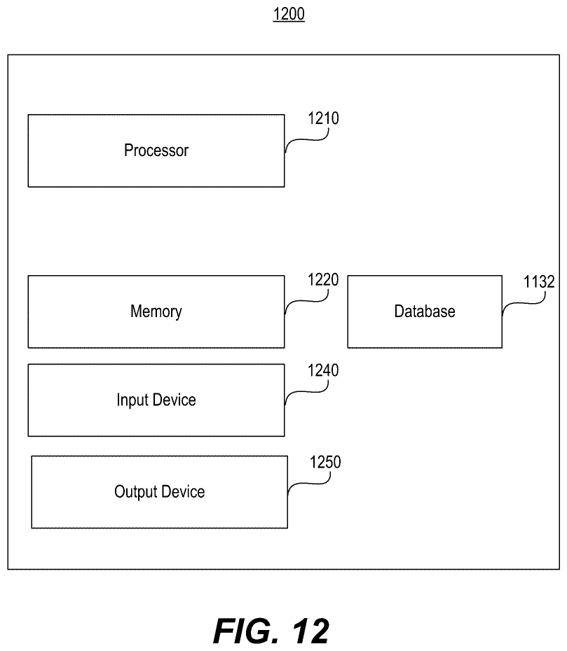

User endpoint device 1120 may communicate with server 1130 through network 1140. For example, user endpoint device 1120 may transmit recorded activity of user 1112 to computing device 1130. computing device 1130 may include any form of remote computing device configured to receive, store, and transmit data. For example, computing device 1130 may be a server configured to store files accessible through a network (e.g., a web server, application server, virtualized server, etc.). computing device 1130 may be implemented as a Software as a Service (SaaS) platform through which software for auditing recorded user activity may be provided to an organization as a web-based service. In some embodiments, computing device 1130 may be a decoupled Python server. Financial institution endpoint device 1110 may similarly communicate with computing device 1130 through network 1140. User endpoint device 1120 and financial institution endpoint device 1110 may include some or all of components in FIG. 12, further discussed below.

FIG. 12 is a block diagram showing an example server 1200, consistent with the disclosed embodiments. For example, server 1200 may be an example implementation of server 1130. Server 1200 may be a computing device (e.g., a server, etc.) and may include one or more dedicated processors and/or memories. For example, server 1200 may include a processor (or multiple processors) 1210, and a memory (or multiple memories) 2220.

Processor 1210 may take the form of, but is not limited to, a microprocessor, embedded processor, or the like, or may be integrated in a system on a chip (SoC). Furthermore, according to some embodiments, processor 1210 may be from the family of processors manufactured by Intel®, AMD®, Qualcomm®, Apple®, NVIDIA®, or the like. The processor 1210 may also be based on the ARM architecture, a mobile processor, or a graphics processing unit, etc. The disclosed embodiments are not limited to any type of processor configured in server 1130.

Memory 1220 may include one or more storage devices configured to store instructions used by the processor 1210 to perform functions related to server 1130. The disclosed embodiments are not limited to particular software programs or devices configured to perform dedicated tasks. For example, the memory 1220 may store a single program, such as a user-level application, that performs the functions associated with the disclosed embodiments, or may comprise multiple software programs. Additionally, the processor 1210 may, in some embodiments, execute one or more programs (or portions thereof) remotely located from server 130. Furthermore, memory 1220 may include one or more storage devices configured to store data for use by the programs. Memory 1220 may include, but is not limited to a hard drive, a solid-state drive, a CD-ROM drive, a peripheral storage device (e.g., an external hard drive, a USB drive, etc.), a network drive, a cloud storage device, or any other storage device.

In some embodiments, memory 1130 may include input device 1240. Computing device 1130 may include one or more digital and/or analog devices that allow computing device 1130 to communicate with other machines and devices, such as other components of system 1100. Computing device 1130 may include one or more input/output devices. Input device 1240 may be configured to receive input from the user of computing device 1130, and one or more components of computing device 1130 may perform one or more functions in response to the input received. In some embodiments, input device 1240 may include an interface displayed on a touchscreen (e.g., output device 1250). Output device 1250 may may include a screen for displaying communications to a user. For example, output device 1250 may include a display configured to display the information relating to the transaction. Computing device 1130 may include other components known in the art for interacting with a user. Output device 1250 may also include one or more digital and/or analog devices that allow a user to interact with system 1100, such as touch sensitive area, keyboard, buttons, or microphones.

In some embodiments, memory 1220 may include a database 1132. Database 1132 may be included on a volatile or non-volatile, magnetic, semiconductor, tape, optical, removable, non-removable, or other type of storage device or tangible or non-transitory computer-readable medium. Database 1132 may also be part of server 1230 or separate from server 1230. When database 1232 is not part of server 1230, server 1230 may exchange data with database 1232 via a communication link. Database 1232 may include one or more memory devices that store data and instructions used to perform one or more features of the disclosed embodiments. Database 1232 may include any suitable databases, ranging from small databases hosted on a work station to large databases distributed among data centers. Database 1232 may also include any combination of one or more databases controlled by memory controller devices (e.g., server(s), etc.) or software. For example, database 1232 may include document management systems, Microsoft SQL™ databases, SharePoint™ databases, Oracle™ databases, Sybase™ databases, other relational databases, or non-relational databases, such as mongo and others.

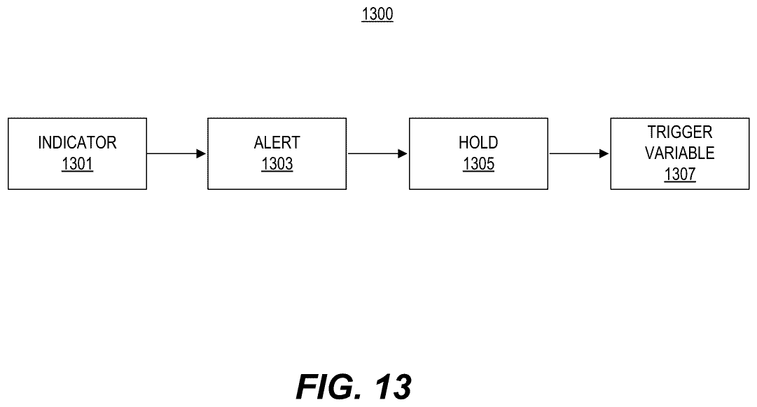

FIG. 13 depicts an exemplary process flow diagram for an analytic workflow of the Deposit Fraud Model. In process flow 1300, an indicator 1301 corresponds to the associated risk indicators of risk indicators 1006. An alert 1303 may be generated based on indicator 1301 as described with reference to FIG. 10. The output of the alert 1303 causes one of those risk result of auto-hold, or analyst review for hold 1305. Hold 1305 can trigger a variety of further actions including a trigger variable 1307. Trigger variable 1307 includes data relating to the Deposit Fraud Model 1005 for representing transactions that are returned to the financial institution within 90 days of a user's profile being processed as having high risk, e.g., based on log-scaling the user's profile, as described above. Trigger variable 1307 may provide information relating to unauthorized transactions flowing through the at least one or more channels such as the ATM, Mobile and Teller channels as it indicates which unauthorized devices are attempting to defraud accounts through the user's account.

In some embodiments, a method includes generating, by a machine learning model executed by the at least one processor, an indicator that is expressed as a severity associated with unauthorized activity for a processed action of a user, the machine learning model being trained to predict a likelihood of unauthorized activity for the processed action. This indicator is the same as the two-digit risk indicator discussed above. As used herein, the term “machine learning model” may refer to an algorithm that uses transactional data, customer characteristics and historical data to predict the likelihood of fraudulent activity. Alternative types of machine learning models may include neural network, bayesian networks, gaussian processes, genetic algorithms, and decision trees.

In some embodiments, the machine learning model is trained to retain information associated with one or more previously generated indicators to tune a currently generated indicator. The information may be used to tune the information used to generate the previous indicator. Tuning as used herein may refer to an experimental process of finding optimal values of hyperparameters to maximize model performance. As used herein and generally understood in the art, hyperparameters are values selected to control a learning process of a model. The tuning occurs once the model receives relevant additional information that may include transactional data, customer characteristics, and historical data to optimize the performance of the model to correctly detect fraudulent transactions.

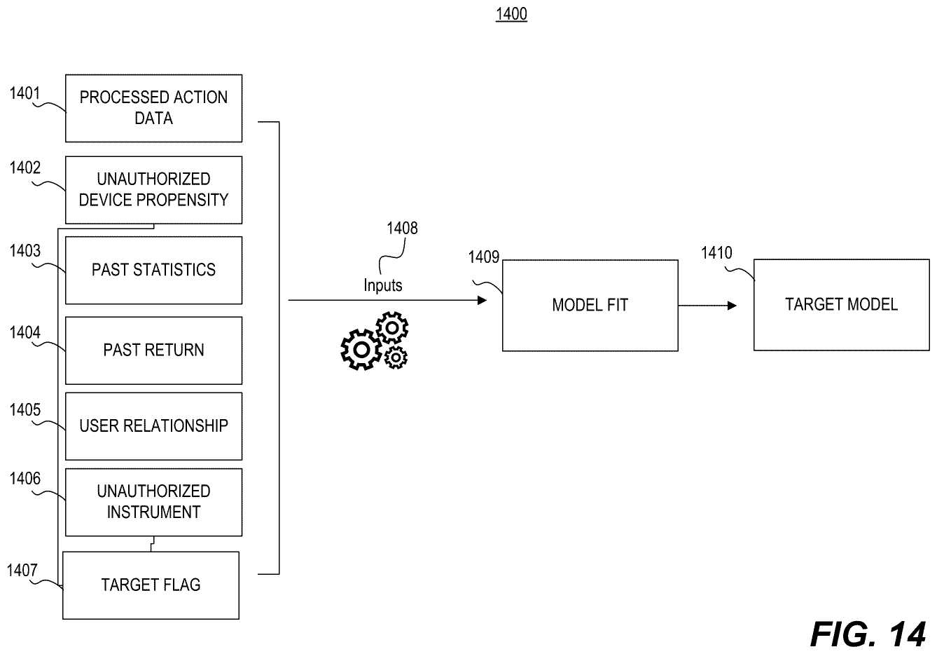

FIG. 14 depicts an exemplary illustration of training a machine learning model for generating risk indicators. As illustrated in FIG. 14, the machine learning model may be trained based on various factors. Once the machine learning model is trained, the machine learning model may be provided with information about a particular transaction, e.g., a financial transaction used as described herein. Then the machine learning model may output a two-digit indicator, e.g., the risk indicator as described herein. FIG. 14 illustrates exemplary inputs that may be used to train the machine learning model. Such inputs may include, for example, processed action data 1401, unauthorized device propensity 1402, past statistics 1403, past return 1404, user relationship 1405, unauthorized instrument 1406, and target flag 1407. Target model 1410 represents the trained machine learning model.

In system 1400, processed action data 1401 may include information relating to transactional data collected from a user's account such as bank transactions that include deposits, withdrawals, wire transfers, and bill payments made by the user's account.

In system 1400, unauthorized device propensity 1402 may include information regarding whether the depositing channel has had any returns or charge-offs associated with it. Charge-offs as used herein may refer to funds that are debts unlikely to be repaid. The device propensity as used herein may refer to the inclination of a user's device to be associated with unauthorized activity due to past fraudulent transactions. The depositing channel as used herein may refer to any of the at least one more channels, such as the ATM, Mobile and Teller channels described above with reference to FIG. 10.

In system 1400, past statistics 1403 may refer to historical data that represents past events that may be stored for eventual analysis for the Deposit Fraud Model 1005. Past events as used herein, may refer to previous events that indicate the likelihood of a user's susceptibility to fraud. For example, a user's history of overdrafts, bounced checks, and unpaid debts, which may be indicative of fraudulent behavior. Past statistics 1403 may also include information regarding historical data about deposit account information that may include a user's credit score, past payments, account number, and account balance.

In system 1400, past return 1404 may include information including an accumulated or aggregated sum of previous returns. Returns as used herein may refer to the return of bad checks, such as checks not honored by the financial institution. Aggregated as used herein, may refer to information that is summarized into significant information, which provides accurate measurements such as sum, average and count. Previous returns may refer to the total returns associated with the user's account. For example, past return 1404 may calculate previous returns from the depositing account by aggregating the sum of total returns associated with the user's account during a specific time period.

In system 1400, user relationship 1405 may include information that enriches information of a user's indicator with information associated with the user's profile as described above with respect to customer characteristics. For example, user relationship 1405 enriches the deposit account information with information from that user's account with other accounts of the same user.

In system 1400, unauthorized instrument 1406 may contain information about a check maker and routing number. Check maker as used herein may refer to the account holder. Furthermore, this enables creation of a variable that measures the risk associated with a particular check maker, to determine if they have a history of returns, e.g., returns of bad checks, or charge offs. The variable may measure the risk based on the probability of an unauthorized action occurring for a user's account, as presumably described. Instrument as used herein may refer to a negotiable instrument, i.e., a promise or order to pay a fixed amount of money described in the promise or order, e.g., a check.

In system 1400, target flag 1407 may contain information that indicates that fraudulent activity may exist. Target flag 1407 would be provided as input to unauthorized instrument 1406 and unauthorized device propensity 1402. Target flag 1407 may be the input that is responsible for appending data relating to the unauthorized instrument 1406 and unauthorized device propensity 1402 for the training of the machine learning model. All the described inputs 1401-1407, would be represented as inputs 1408 that are combined. Inputs 1408 are all fed into a model fit 1409. Model fit 1409 represents a measurement of how well the machine learning model adapts to data that is similar to the data on which it was trained. Model fit 1409 accurately approximates the output, target model 1410, once provided with inputs 1408.

Transactions may be enriched in real time using the input variables shown in FIG. 14 respectively. As described above, inputs 1401-1407, provide elements that enrich the information available for a particular transaction. Such enrichment was described above with reference to FIG. 10.

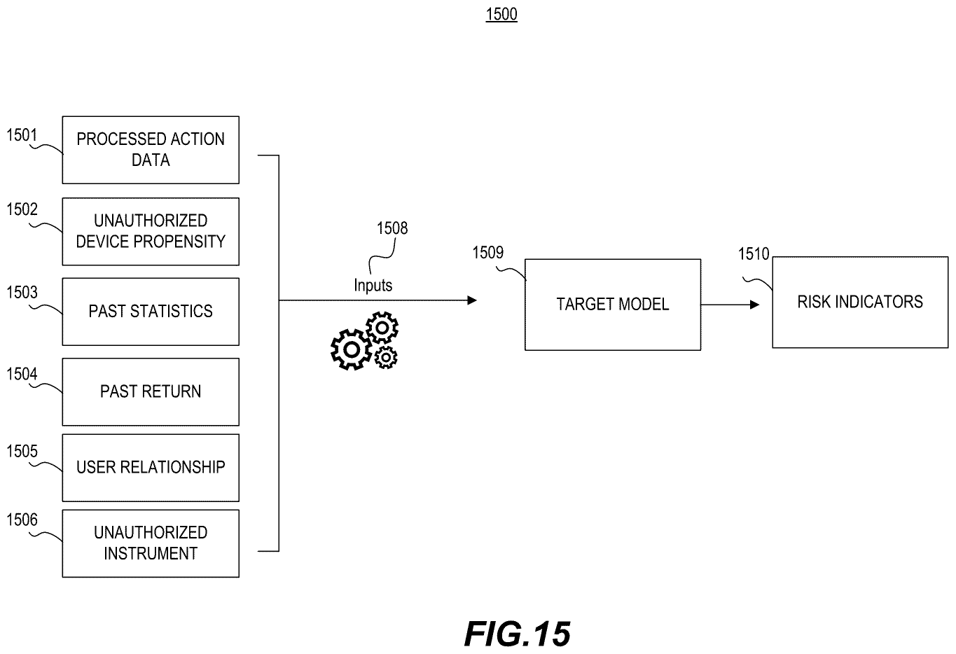

FIG. 15 depicts an exemplary illustration of the execution of a trained machine learning model for generating risk indicators. To generate the risk indicators, the trained machine learning model receives various inputs 1501-1506, which generally correspond to inputs 1401-1406, respectively, described above with respect to FIG. 14. The target model 1509 that corresponds to target model 1410, may be implemented in FIG. 15 to generate the risk indicators after the execution of the model.

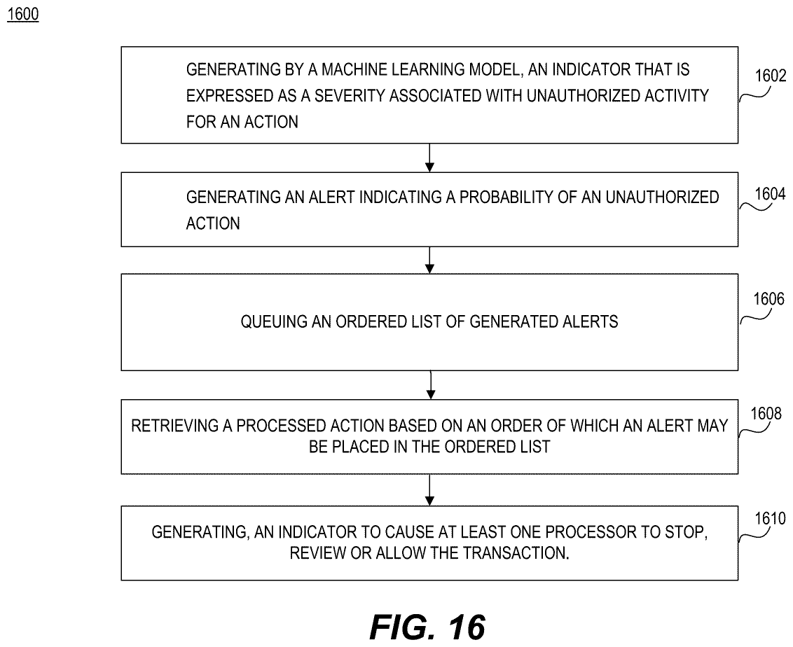

FIG. 16 depicts a flowchart of a method 1600 for the Deposit Fraud Model. Method 1600 may include a step 1602 of generating as explained above with respect to FIG. 15. For example, the machine learning model may be used to generate the risk indicator by training the model using the processes described above with respect to FIG. 14 earlier. Method 1600 may include a step 1604 of generating as explained above with respect to FIG. 10, an alert indicating a probability of an unauthorized action, as for example. Method 1600 may include a step 1606 of queuing as explained above with respect to FIG. 10, an ordered list of generated alerts for example. Method 1600 may include a step 1608 of retrieving as explained above with respect to FIG. 10, a processed action based on an order of which the alert may be placed in the ordered list, as for example, method 1600 may include a step of 1610 of determining, as explained above with respect to FIG. 10, whether the processed action may be determined to be unauthorized by causing the at least one processor to stop, review, or allow the transaction.

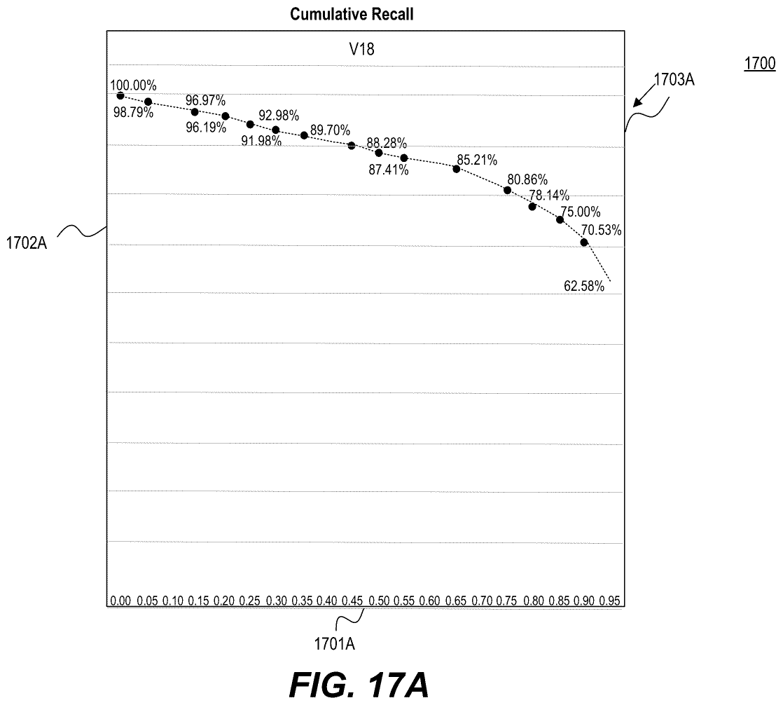

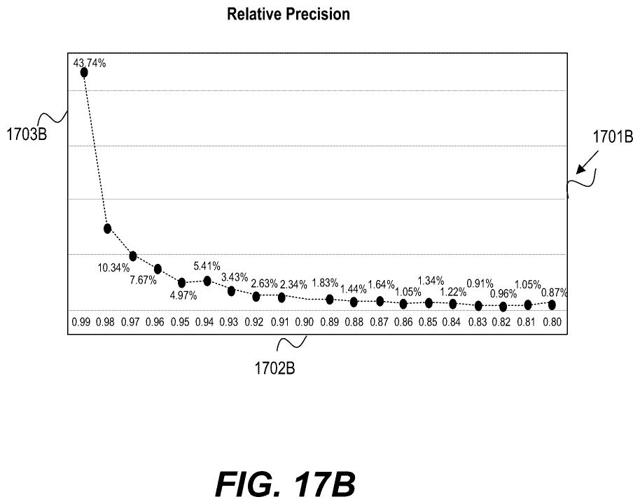

FIG. 17A depicts an exemplary graph 1700 for Deposit Fraud Model benchmarking and monitoring for the Deposit Fraud Model. The x-axis 1701A of graph 1700 represents a risk indicator, while the y-axis 1702A represents a calculated cumulative recall for transactions. Cumulative recall represents a proportion of fraudulent transactions that have been accurately identified for fraud in graph 1701A. The accuracy is determined by the Deposit Fraud Model 1005. For example, if a transaction has risk indicator of 10 and may be now assigned a low-risk indicator, then the Deposit Fraud Model 1005 would collect transactional data on the actual transaction to determine, if there was a definite result of low risk or high risk of fraud for that transaction. Graph 1703A identifies the calculated percentage values for cumulative recall of graph 1700.

For example, if the Deposit Fraud Model 1005 receives a plurality of transactions that are considered “low-risk”, it may be, determined that 95% of transactions are correctly identified as low-risk, the remaining 5%, and the analyst would have determined that the remaining 5% were incorrectly identified as low-risk. The cumulative recall for the transactions, would be 0.95, by a formula for recall; recall=TruePositives/(TruePositives+FalseNegatives)=95/(95+5)=0.95.

Furthermore, the Deposit Fraud Model 1005 may correctly identify fraudulent transactions by machine learning to appropriately classify transactions as fraudulent or non-fraudulent. For example, the Deposit Fraud Model 1005 may calculate a recall rate of 62%, in which the recall percentage value may be calculated by the number of true positives divided by the sum of the number of true positives and the number of false positives. The recall rate of 62% represents that the Deposit Fraud Model 1005, has correctly identified 62 of the 100 fraudulent or non-fraudulent transactions shown. True positives may refer to correctly identified fraudulent or non-fraudulent transactions and false positives may refer to fraudulent or non-fraudulent transactions that were not correctly identified. False positives may refer to incorrectly identified fraudulent or non-fraudulent transactions. A higher recall indicates that the Deposit Fraud Model 1005 is able to successfully identify fraudulent or non-fraudulent transactions. The x-axis 1701A represents the transactions that were analyzed and y axis 1703A represents the percentage of correctly identified transactions. A recall rate at the rate of 60%, may suggest that the Deposit Fraud Model 1005 should be evaluated, to provide a more effective model for correctly identifying fraudulent transactions. A higher cumulative recall percentage rate indicates that the Deposit Fraud Model 1005 has more accurately indicated the fraudulent transactions.

FIG. 17B depicts an exemplary graph 1701B for Deposit Fraud Model benchmarking and monitoring relating to relative precision for the Deposit Fraud Model 1005. More particularly, graph 1701B depicts a graph for relative precision rates that measure a ratio of the number of true positives and false positives. X-axis 1702B represents a fraction of transactions that were correctly identified as fraudulent or non-fraudulent. Y-axis 1703B represents the percentage of those transactions that were correctly identified as fraudulent. These values for the x-axis 1702b and y-axis 1703b may be obtained by a formula for relative precision: The number of true positives divided by the sum of the true positives and false negatives. Relative precision as used herein may refer to a metric used for evaluating the performance of the Deposit Fraud Model 1005. True positives as used herein may refer to outcomes, in which the Deposit Fraud Model 1005 correctly predicts, the transactions that are fraudulent. False negatives as used herein may refer to outcomes in which the Deposit Fraud Model 1005 incorrectly predicts the non-fraudulent transactions.

For example, the Deposit Fraud Model 1005, may have identified over 100 transactions as being potentially fraudulent, as depicted on the x-axis 1702b on the graph. At y-axis 1703B, at the 100^{th} transaction, the Deposit Fraud Model 1005 determines that 44 of the 100 transactions are fraudulent, which would be true positives. Moreover, the relative precision rate of the Deposit Fraud Model 1005 would be 44% as depicted in graph 1701B, with the remaining 56 transactions being incorrectly identified, which would be false negatives. A higher relative precision rate indicates more accurate prediction of fraud by the Deposit Fraud Model 1005 while minimizing false negatives by the Deposit Fraud Model 1005.

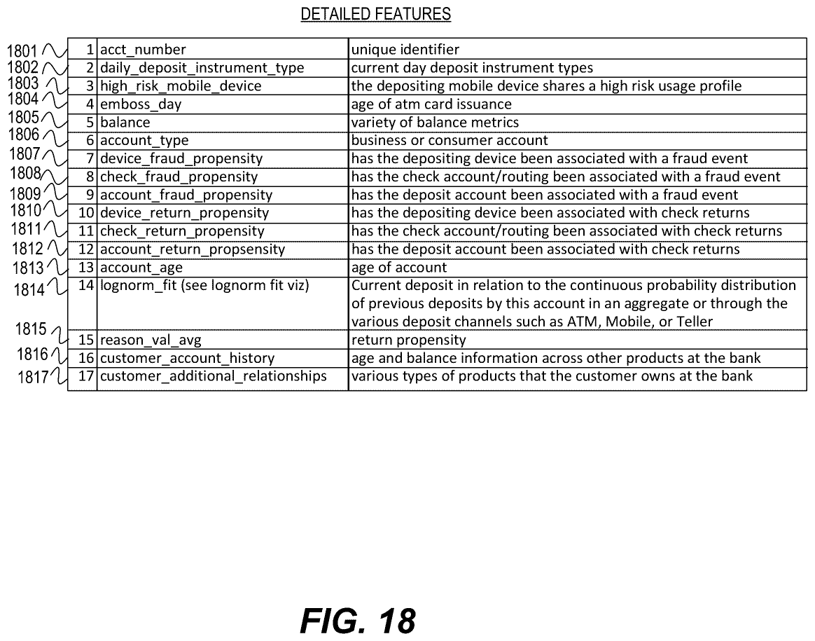

FIG. 18 depicts a table 1800 illustrating an exemplary feature list relating to the Deposit Fraud Model 1005 as described in the detailed implementation of FIG. 10. Table 1800 depicts a detailed feature list relating to the individual inputs described with reference to FIG. 14, such as processed action data 1401, unauthorized device propensity 1402, past statistics 1403, past return 1404, user relationship 1405, and unauthorized instrument 1406, to define individual characteristics for determining fraud associated with each individual input variable 1408.

More particularly, table 1800 may include feature 1801 “account number” which may be a unique identifier representing a user's account number that may be assigned by the financial institution, to identify the account of the user. Table 1800 may include feature 1802 “daily deposit instrument type,” which may represent a same day deposit for a transaction. Table 1800 may include feature 1803 “high_risk_mobile_device” which may represent the depositing mobile device that has a high-risk usage profile. For example, user 101 in FIG. 6 may have a mobile device that may be susceptible to higher risk due to past fraudulent activity associated with the user's account on that mobile device. Table 1800 may include feature 1804 “emboss_day” which may represent the age of an ATM card the user uses to deposit funds into an ATM. Table 1800 may include feature 1805 “balance”, which may represent a variety of balance metrics. Examples of the variety of balance metrics may include metrics for a measure or representation of the user's balance such as assessing the balance in the account against a predetermined value, percentage, or threshold. Table 1800 may include feature 1806 “account type” which may represent identification of an account as a business, consumer account, checking account, or savings account, into which funds may be deposited.

Table 1800 may include feature 1807 “device_fraud_propensity” which may represent an extent to which, a depositing mobile device previously has been associated with fraudulent events. The depositing mobile device represents whether there has been any returns or charge-offs associated with the mobile device, charge-offs referring to debts that have been written off due to unlikeliness of being collected, as described above with reference to FIG. 14. Table 1800 may include feature 1808 “check_fraud_propensity”, which may represent an extent to which, a check account or routing number has previously been associated with fraudulent events. Table 1800 may include feature 1809 “account_fraud_propensity”, which may represent a deposit account that has previously been associated with a fraudulent event.

Table 1800 may include feature 1810 “device_return_propensity” which may represent an extent to which, a depositing mobile device has previously been associated with fraudulent check returns. The depositing mobile device used, may be the same depositing device used in the description of feature 1807 and 1803. The depositing mobile device in this situation, may represent how often it has had fraudulent check returns, once the user attempts to deposit a fraudulent check by means of the depositing device. Table 1800 may include feature 1811 “check_return_propensity” which may represent an extent to which, a check account or routing number has previously been associated with check returns, wherein check returns refers to the number of times that a check has been returned due to suspicion of fraudulent activity. Table 1800 may include feature 1812 “account_return_propensity” which may represent an extent to which, a deposit account has previously been associated with check returns.

Table 1800 may include feature 1813 “account age” which may represent the age of an account, i.e., how long the user has had the account. Table 1800 may include feature 1814 “lognorm_fit”, which may represent a current deposit in relation to a continuous probability distribution of previous deposits. Continuous probability distribution as used herein, may refer to the probability distribution in which a random variable can take on any value continuously. Table 1800 may include feature 1815 “reason_val_avg”, which may represent a return propensity. The return propensity may refer to the likelihood of the user making repeat transactions to their account that result in a return of a fraudulent check. Table 1800 may include feature 1816 “customer account history” which may represent the age and balance information for different products at the financial institution for a particular customer. Table 1800 may include feature 1817 “customer_additional_relationships” which may represent the various types of products that the customer has at the financial institution.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally comprise a “network” or a “computer network”.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

Systems and methods disclosed herein involve unconventional improvements over conventional approaches. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

It is appreciated that the above described embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units can be combined as one module or unit, and each of the above described modules/units can be further divided into a plurality of sub-modules or sub-units.

The block diagrams in the figures illustrate the architecture, functionality, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as example only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It will be appreciated that the embodiments of the present disclosure are not limited to the exact construction that has been described above and illustrated in the accompanying drawings, and that various modifications and changes may be made without departing from the scope thereof. Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Computer programs based on the written description and methods of this specification are within the skill of a software developer. The various programs or program modules can be created using a variety of programming techniques. One or more of such software sections or modules can be integrated into a computer system, non-transitory computer readable media, or existing software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application. These examples are to be construed as non-exclusive.

Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

1-21. (canceled)

22. A computer-implemented method for identifying unauthorized activity in a computing system including at least one processor, the method being performed by the at least one processor and comprising:
receiving, by the at least one processor from a transaction channel, a processed action of a user;
generating, by a machine learning model, a risk indicator associated with unauthorized activity at the transaction channel for the processed action of the user;
transmitting, by the at least one processor to the transaction channel, an alert based on the generated risk indicator;
generating, by the machine learning model, an action indicator based on the generated risk indicator and the transmitted alert; and
executing an outcome based on the generated action indicator.

23. The method of claim 22, wherein:
responsive to a determination that the risk indicator is below a first predetermined threshold, assigning a low risk indicator value;
responsive to a determination that the risk indicator is above the first predetermined threshold and below a second predetermined threshold, assigning a medium risk indicator value; and
responsive to a determination that the risk indicator is above the second predetermined threshold, assigning a high risk indicator value.

24. The method of claim 23, wherein responsive to an assignment of the low risk indicator value, allowing the processed action of the user.

25. The method of claim 23, wherein responsive to an assignment of the medium risk indicator value, flagging the processed action of the user.

26. The method of claim 25, wherein flagging the processed action of the user comprises reviewing the processed action.

27. The method of claim 23, wherein responsive to an assignment of the high risk indicator value, stopping the processed action of the user.

28. The method of claim 27, wherein stopping the processed action of the user comprises holding the processed action of the user for a predetermined time.

29. The method of claim 22, further comprising training the machine learning model to predict a likelihood of unauthorized activity for the processed action.

30. The method of claim 22, wherein the risk indicator is further generated based on a log-norm scaling of a user's profile against the user's profile.

31. The method of claim 22, further comprising appending, to the processed action, customer characteristics and historical data associated with the processed action.

32. A computing system for identifying unauthorized activity comprising:
at least one processor configured to:
receive, from a transaction channel, a processed action of a user;
generate, by a machine learning model, a risk indicator associated with unauthorized activity at the transaction channel for the processed action of the user;
transmit, by the at least one processor to the transaction channel, an alert based on the generated risk indicator;
generate, by the machine learning model, an action indicator based on the generated risk indicator and the transmitted alert; and
execute an outcome based on the generated action indicator.

33. The system of claim 32, wherein the at least one processor is further configured to:
responsive to a determination that the risk indicator is below a first predetermined threshold, assign a low risk indicator value;
responsive to a determination that the risk indicator is above the first predetermined threshold and below a second predetermined threshold, assign a medium risk indicator value; and
responsive to a determination that the risk indicator is above the second predetermined threshold, assign a high risk indicator value.

34. The system of claim 33, wherein responsive to an assignment of the low risk indicator value, the at least one processor is further configured to allow the processed action of the user.

35. The system of claim 32, wherein responsive to an assignment of the medium risk indicator value, the at least one processor is further configured to flag the processed action of the user.

36. The system of claim 35, wherein the flag comprises a review of the processed action.

37. The system of claim 33, wherein responsive to an assignment of the high risk indicator value, the at least one processor is further configured to stop the processed action of the user.

38. The system of claim 37, wherein the stop comprises a hold of the processed action of the user for a predetermined time.

39. The system of claim 32, wherein the risk indicator is further generated based on a log-norm scaling of a user's profile against the user's profile.

40. The system of claim 32, wherein the at least one processor is further configured to append, to the processed action, customer characteristics and historical data associated with the processed action.

41. A non-transitory computer-readable medium storing a set of instructions for identifying unauthorized activity in a computing system including at least one processor, the set of instructions comprising:
one or more instructions that, when executed by the at least one processor of the computing system, cause the computing system to:
receive, by the at least one processor from a transaction channel, a processed action of a user;
generate, by a machine learning model, a risk indicator associated with unauthorized activity at the transaction channel for the processed action of the user;
transmit, by the at least one processor to the transaction channel, an alert based on the generated risk indicator;
generate, by the machine learning model, an action indicator based on the generated risk indicator and the transmitted alert; and
execute an outcome based on the generated action indicator.
